(19) United States
(12) Patent Application Publication
(10) Pub. No.: US 2015/0048252 A1
(43) Pub. Date: Feb. 19, 2015

(54) TIME RESOLVED INFORMATION COMPRESSION

(71) Applicant: Allegheny-Singer Research Institute, Pittsburgh, PA (US)

(72) Inventor: Mark Doyle, Wexford, PA (US)

(21) Appl. No.: 14/394,362

(22) PCT Filed: Apr. 24, 2013
(86) PCT No.: PCT/US13/37969

§ 371 Date: Oct. 14, 2014

Related U.S. Application Data
(60) Provisional application No. 61/638,081, filed on Apr. 25, 2012.

(51) Int. Cl. G01T 1/29

(52) U.S. Cl. CPC G01T 1/2985
USPC 250/363.04

(57) ABSTRACT

A method, system and device time resolved information compression. One or more detectors receive a plurality of protons, and a processing device resolves the received plurality of photons into a sample signal shown in a time domain. The processing device transforms the received plurality of photons as shown in the time domain into a frequency response shown in a frequency domain based upon a rate of detection of the plurality of photons and isolates a frequency peak position in the frequency response. The processing device further converts the frequency peak position into projection data.

### CROSS REFERENCE TO RELATED APPLICATIONS

This application is a national stage application of, and claims priority to, International Patent Application No. PCT/US2013/037969, filed Apr. 24, 2013, which in turn claims priority to U.S. Provisional Patent Application No. 61/638,081 filed Apr. 25, 2012. The disclosures of each priority application are fully incorporated herein by reference.

### BACKGROUND

In magnetic resonance imaging (MRI), it is now common to employ compressed sensing (e.g. MACH) whereby data normally acquired in one domain (e.g. k-space) can be represented in a compressed format in another domain (e.g. time). The redundancy in the data can be exploited to reduce the acquisition time or increase the information content, depending on the degree and type of data compression. Some variants on these approaches have been applied to other modalities such as Nuclear Single Photon Emission Computed Tomography (SPECT).

Imaging technologies such as SPECT and Positron Emission Topography (PET) involve detection of high-energy photons that are the result of a radioactive decay process. Typically, the detectors are configured to count the number of photons that enter through a collimated aperture to a detector (such as a photo multiplier tube). To differentiate between regions, the detector remains at one location for several seconds prior to moving to a new location and the total photon count during that time is recorded for each region. Typically, the projective information is acquired at several angles around the patient (in PET and SPECT imaging, the detectors systematically move around the patient to cover 180 degrees of projective data). Thus, for each position of the detector, the summed count of the number of radioactive decays is measured and used to form the projection information that contributes to the tomographic image. Unlike MRI, where the signal is generated in the form of distinct frequencies (formed by superimposition of controlled magnetic gradients) the radioactive decay process in SPECT and PET is random. However, with a sufficiently large source of radioactive material, the stream of photons received at each detector is almost continuous.

### BRIEF DESCRIPTION OF THE DRAWINGS

FIG. 1 illustrates a received photon sample in both the time and frequency domains.

FIG. 2 is an ordered sampling of various disease components according to an embodiment.

FIG. 3 illustrates a flowchart showing a process for performing time resolved information compression according to an embodiment.

FIG. 4 illustrates various elements of a computing device for implementing various methods and processes described herein.

### SUMMARY

In one general respect, a first embodiment discloses a method of time resolved information compression. The method includes receiving a plurality of photons, resolving the received plurality of photons into a sample signal shown in a time domain, transforming the sample signal as shown in the time domain into a frequency response shown in a frequency domain based upon a rate of detection of the plurality of photons, isolating a frequency peak position in the frequency response, and converting the frequency peak position into projection data related to an area of interest being examined for a patient

The first embodiment further discloses transforming the received plurality of photons as shown in the time domain comprises applying a Fourier transform to the rate of detection. Similarly, the first embodiment further discloses that the frequency domain is determined based upon operational parameters of the detector. Similarly, the first embodiment further discloses centering the frequency peak position based upon a rate of signal arrival at the detector. The first embodiment further discloses plotting the frequency peak position in the frequency domain. Similarly, the first embodiment further discloses that the plurality of photons are radioactive decay photons.

In addition, the first embodiment discloses receiving a second plurality of photons. Similarly, the first embodiment further includes resolving the received second plurality of photons into the sample signal.

In another general respect, a second embodiment discloses a system for time resolved information compression. The system includes a detector configured to receive a plurality of protons, a processing device operably connected to the detector, and a non-transitory computer readable medium operably connected to the processing device, the computer readable medium containing a set of instructions. The instructions are configured to cause the processing device to receive an indication of the received plurality of protons from the detector, resolve the received plurality of photons into a sample signal shown in a time domain, transform the received plurality of photons as shown in the time domain into a frequency response shown in a frequency domain based upon a rate of detection of the plurality of photons, isolate a frequency peak position in the frequency response, and convert the frequency peak position into projection data.

The second embodiment further discloses that the instructions for causing the processing device to transform the received plurality of photons as shown in the time domain instructions for causing the processing device to apply a Fourier transform to the rate of detection. Similarly, the second embodiment further discloses that the frequency domain is determined based upon operational parameters of the detector. Similarly, the second embodiment further discloses instructions for causing the processing device to center the frequency peak position based upon a rate of signal arrival at the detector. The second embodiment further discloses instructions for causing the processing device to plot the frequency peak position in the frequency domain. Similarly, the second embodiment further discloses that the plurality of photons are radioactive decay photons.

In addition, the second embodiment further discloses a second detector operably connected to the processing device and configured to receive a second plurality of photons. Similarly, the second embodiment further discloses instructions for causing the processing device to resolve the received second plurality of photons into the sample signal.

In another general respect, a third embodiment discloses a device for time resolved information compression. The device includes a plurality of detectors, wherein each of the plurality of detectors is configured to receive at least a portion of a plurality of radioactive decay photons, a processing device operably connected to each of the plurality of detectors and a non-transitory computer readable medium operably connected to the processing device, the computer readable medium containing a set of instructions. The instructions are configured to cause the processing device to receive an indication of the received plurality of protons from the plurality of detectors, resolve the received plurality of photons into a sample signal shown in a time domain, transform the received plurality of photons as shown in the time domain into a frequency response shown in a frequency domain based upon a rate of detection of the plurality of photons, isolate a frequency peak position in the frequency response, and convert the frequency peak position into projection data.

The third embodiment further discloses that the instructions for causing the processing device to transform the received plurality of photons as shown in the time domain instructions for causing the processing device to apply a Fourier transform to the rate of detection. Similarly, the third embodiment further discloses that the frequency domain is determined based upon operational parameters of the plurality of detectors. Similarly, the third embodiment discloses that the set of instructions further includes instructions for causing the processing device to center the frequency peak position based upon a rate of signal arrival at the plurality of detectors.

### DETAILED DESCRIPTION

This disclosure is not limited to the particular systems, devices and methods described, as these may vary. The terminology used in the description is for the purpose of describing the particular versions or embodiments only, and is not intended to limit the scope.

As used in this document, the singular forms “a”, “an”, and “the” include plural references unless the context clearly dictates otherwise. Unless defined otherwise, all technical and scientific terms used herein have the same meanings as commonly understood by one of ordinary skill in the art. Nothing in this document is to be construed as an admission that the embodiments described in this document are not entitled to antedate such disclosure by virtue of prior invention. As used in this document, the term “comprising” means “including, but not limited to.” As used in this document, the terms “sum”, “product” and similar mathematical terms are construed broadly to include any method or algorithm in which a single datum is derived or calculated from a plurality of input data.

As used herein, the term “modality” refers to a mode, process or method of obtaining a set of data. For example, a modality may include a specific medical test or an imaging process that may be used to obtain and/or assess biological information about a medical patient.

The term “processing device” refers to one or more computing devices configured to operate as defined by one or more instructions to perform at least a specific process. Multiple computing devices may be organized into a group of devices, and a processing device, as used herein, may include any combination of computing devices contained within the group.

The present disclosure is directed to a simplified technique for interpreting received radioactive decay photons named time resolved information compression (TRIC). The TRIC techniques as taught herein may be incorporated to further compress SPECT type data to achieve additional substantial advantages, including, higher signal-to-noise (SNR), increased resolution, lower radiation doses and faster scanning.

In TRIC, instead of counting the number of photons over the measurement interval, the data are time resolved such that the time of reception of each photon is registered. Thus, over a measurement period (e.g. 10 seconds) information may be gathered not only to register the number of photons but also the time of arrival of each photon.

During this extended measurement time, the photons arrive at the detector at an average rate. For example, if the photon arrival count is 500 for detector #1 and 250 for detector #2, then on average, the rate of photon detection is double for detector #1 as compared to detector #2. In an example where the measurement duration is 10 sec, the average rate of detection for detector # 1 is 50 Hz and 25 Hz for detector #2.

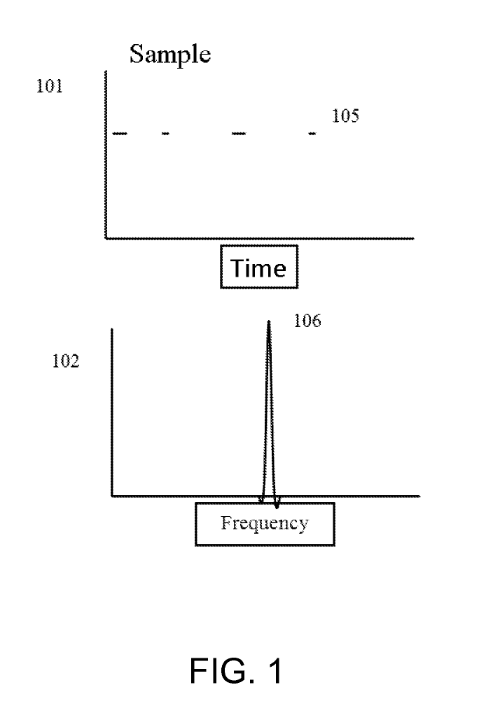

The sampled data can be Fourier transformed to show the “response” in the frequency domain, thereby resolving the sampled data into a more compressed format for use with the TRIC technique. As shown in FIG. 1, a sample may be received by a detector and resolved in the time domain as shown in plot 101. The sample shows various indications 105 of the arrival of photons at the detector but, without additional extensive computation, actual projection data is not readily available from the time domain information. However, plot 102 shows the indications 105 in the time domain of plot 101 transformed (e.g., via the Fourier transform) into the frequency domain. A single frequency response peak position 106 may be clearly seen in the frequency domain plot 102, the frequency response peak being easily converted into projection data according to traditional projection techniques. The position of the frequency response peak position may be centered around the rate of signal arrival.

To continue the above example, in the case of detector #1 the temporally resolved and transformed response may be in the form of a sharp spike at 50 Hz, and in the case of detector #2, a sharp spike at 25 Hz, with no other data present at any other frequency. Thus, in this idealized case, TRIC has achieved extreme compression of the sampled data into one point in the frequency domain per detector. This compression is one of the primary sources of the advantages of TRIC over conventional detection schemes, and it can be exploited to reduce scan time, increase resolution, reduce radioactive dose, etc.

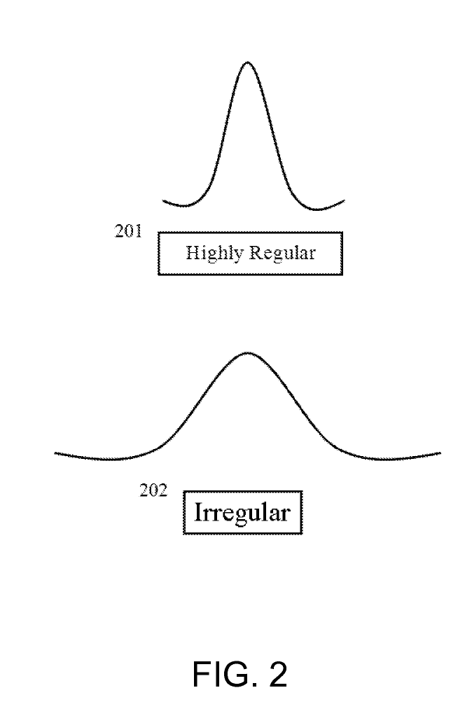

However, the compression is not expected to be as dramatic in reality since the radioactive decay is subject to random events that may act as a source of noise. In the case whereby the rate of photon delivery is not perfectly regular (as is expected in reality), the sharpness of the spike associated with the frequency response peak may be diminished and the spike may become broader. As shown in FIG. 2, a highly regular frequency response peak 201 may include a single, steep spike. An irregular frequency response peak 202 may be diminished and the peak amplitude reduced, thereby broadening the overall appearance of the spike. However, the peak position of the spike may still be centered at the same location, thus demonstrating an immunity of peak position to noise and signal irregularity. Further, additional noise in the rate of arrival of photons at the detector will Fourier transform to a broad signal in the frequency domain, thereby lowering the peak amplitude while not otherwise altering the position of the frequency response peak. Thus, the frequency response peak position can be detected even in the presence of random noise and some degree of irregularity in the photon signal.

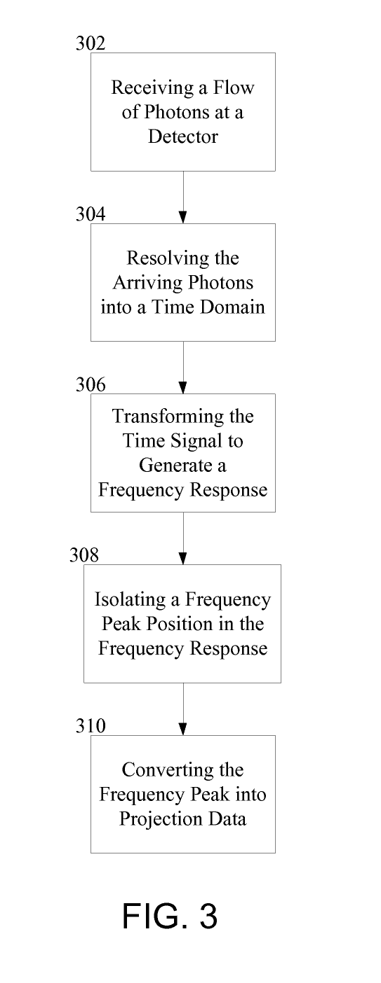

FIG. 3 illustrates a process for performing the TRIC techniques as taught herein, according to an embodiment. A detector may receive 302 a flow of radioactive decay photons from a patient. For example, the patient may have received an injection of a radioactive isotope into an area of interest such that cells of a tumor located in the area of interest emit radioactive decay photons. A processing device operably connected to the detector may receive an indication of the photon arrival and resolve 304 the arriving photons into a sample signal in the time domain, similar to plot 101 as shown in FIG. 1.

It should be noted that the processing device may be integrated into the detector itself. Conversely, the processing device may be a standalone piece of equipment operably connected to the detector via a high speed, high data transfer connection such as a fiber optic connection.

The processing device may transform 306 the time domain based signal into a frequency response signal in the frequency domain via, for example, the Fourier transform. As shown in the plot 102 of FIG. 1, once converted to the frequency domain a single frequency response peak may be shown in the plot. The frequency response peak 308 may be isolated and converted 310 into projection data related to the area of interest being examined on the patient.

It should be noted the process as shown in FIG. 3 is shown by way of example only and may be modified based upon implementation. For example, a filtering step may be included to further increase the SNR of the TRIC technique. Similarly, depending on the capabilities of the detectors, multiple detectors may be used to receive the flow of radioactive decay photons.

In a case where the detector cannot measure the arrival of the radioactive decay photons sufficiently fast, it may be desirable to reduce the amount of radioactive material given to the patient. This has obvious safety and performance advantages for the modality. However, there has to be sufficient radioactive material to approximate a steady rate of delivery of photons such that the transformed data shows a single peak in the frequency domain.

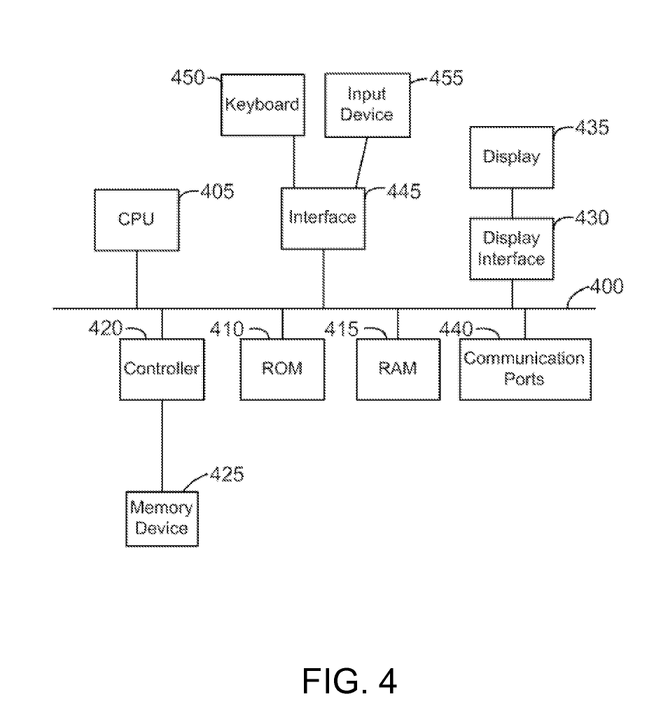

The technology as discussed herein can be retrofitted to a conventional SPECT or PET scanner, or it can be configured as a stand-alone custom designed scanner. FIG. 4 depicts a block diagram of internal hardware that may be used to contain or implement various components to perform the TRIC process illustrated in the previous figures. A bus 400 serves as the main information highway interconnecting the other illustrated components of the hardware. CPU 405 is the central processing unit of the system, performing calculations and logic operations required to execute a program. CPU 405, alone or in conjunction with one or more of the other elements disclosed in FIG. 4, is an illustration of a processing device, computing device or processor as such terms are used within this disclosure. Read only memory (ROM) 410 and random access memory (RAM) 415 constitute examples of memory devices.

A controller 420 interfaces with one or more optional non-transitory memory devices 425 to the system bus 400. These memory devices 425 may include, for example, an external or internal DVD drive, a CD ROM drive, a hard drive, flash memory, a USB drive or the like. As indicated previously, these various drives and controllers are optional devices. Additionally, the memory devices 425 may be configured to include individual files for storing any software modules or instructions, auxiliary data, common files for storing groups of results or auxiliary, or one or more databases for storing the result information, auxiliary data, and related information as discussed above.

Program instructions, software or interactive modules for performing the TRIC process as discussed above may be stored in the ROM 410 and/or the RAM 415. Optionally, the program instructions may be stored on a tangible computer readable medium such as a compact disk, a digital disk, flash memory, a memory card, a USB drive, an optical disc storage medium, and/or other recording medium.

An optional display interface 430 may permit information from the bus 400 to be displayed on the display 435 in audio, visual, graphic or alphanumeric format. The information may include information related various data sets. Communication with external devices may occur using various communication ports 440. A communication port 440 may be attached to a communications network, such as the Internet or an intranet.

The hardware may also include an interface 445 which allows for receipt of data from input devices such as a keyboard 450 or other input device 455 such as a mouse, a joystick, a touch screen, a remote control, a pointing device, a video input device and/or an audio input device. Additionally, the input device 455 may include a photon detector as discussed above, configured to detect and receive radioactive decay photons.

Several of the above-disclosed and other features and functions, or alternatives thereof, may be combined into many other different systems or applications. Various presently unforeseen or unanticipated alternatives, modifications, variations or improvements therein may be subsequently made by those skilled in the art, each of which is also intended to be encompassed by the disclosed embodiments.

What is claimed is:

1. A method, comprising:
receiving, at a detector, a plurality of photons;
resolving, by a processing device operably connected to the detector, the received plurality of photons into a sample signal shown in a time domain;
transforming, by the processing device, the sample signal as shown in the time domain into a frequency response shown in a frequency domain based upon a rate of detection of the plurality of photons;
isolating, by the processing device, a frequency peak position in the frequency response; and
converting, by the processing device, the frequency peak position into projection data related to an area of interest being examined for a patient.

2. The method of claim 1, wherein transforming the received plurality of photons as shown in the time domain comprises applying a Fourier transform to the rate of detection.

3. The method of claim 1, wherein the frequency domain is determined based upon operational parameters of the detector.

4. The method of claim 1, further comprising centering, by the processing device, the frequency peak position based upon a rate of signal arrival at the detector.

5. The method of claim 1, further comprising plotting, by the processing device, the frequency peak position in the frequency domain.

6. The method of claim 1, wherein the plurality of photons are radioactive decay photons.

7. The method of claim 1, further comprising receiving, at a second detector, a second plurality of photons.

8. The method of claim 7, further comprising resolving, by the processing device, the received second plurality of photons into the sample signal.

9. A system comprising:
a detector configured to receive a plurality of protons;
a processing device operably connected to the detector; and
a non-transitory computer readable medium operably connected to the processing device, the computer readable medium containing a set of instructions configured to cause the processing device to:
receive an indication of the received plurality of protons from the detector,
resolve the received plurality of photons into a sample signal shown in a time domain,
transform the received plurality of photons as shown in the time domain into a frequency response shown in a frequency domain based upon a rate of detection of the plurality of photons,
isolate a frequency peak position in the frequency response, and
convert the frequency peak position into projection data.

10. The system of claim 9, wherein the instructions for causing the processing device to transform the received plurality of photons as shown in the time domain instructions for causing the processing device to apply a Fourier transform to the rate of detection.

11. The system of claim 9, wherein the frequency domain is determined based upon operational parameters of the detector.

12. The system of claim 9, further comprising instructions for causing the processing device to center the frequency peak position based upon a rate of signal arrival at the detector.

13. The system of claim 9, further comprising instructions for causing the processing device to plot the frequency peak position in the frequency domain.

14. The system of claim 9, wherein the plurality of photons are radioactive decay photons.

15. The system of claim 9, further comprising a second detector operably connected to the processing device and configured to receive a second plurality of photons.

16. The system of claim 15, further comprising instructions for causing the processing device to resolve the received second plurality of photons into the sample signal.

17. A device comprising:
a plurality of detectors, wherein each of the plurality of detectors is configured to receive at least a portion of a plurality of radioactive decay photons;
a processing device operably connected to each of the plurality of detectors; and
a non-transitory computer readable medium operably connected to the processing device, the computer readable medium containing a set of instructions configured to cause the processing device to:
receive an indication of the received plurality of protons from the plurality of detectors,
resolve the received plurality of photons into a sample signal shown in a time domain,
transform the received plurality of photons as shown in the time domain into a frequency response shown in a frequency domain based upon a rate of detection of the plurality of photons,
isolate a frequency peak position in the frequency response, and convert the frequency peak position into projection data.

18. The device of claim 17, wherein the instructions for causing the processing device to transform the received plurality of photons as shown in the time domain instructions for causing the processing device to apply a Fourier transform to the rate of detection.

19. The device of claim 17, wherein the frequency domain is determined based upon operational parameters of the plurality of detectors.

20. The device of claim 17, further comprising instructions for causing the processing device to center the frequency peak position based upon a rate of signal arrival at the plurality of detectors.
